(19) United States
(12) Patent Application Publication
(10) Pub. No.: US 2004/0078641 A1
(43) Pub. Date: Apr. 22, 2004

(54) Operating system-independent file restore from disk image

(75) Inventor: Michael Fleischmann, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Company

(21) Appl. No.: 10/252,250

(22) Filed: Sep. 23, 2002

(51) Int. Cl. G06F 11/00

(52) U.S. Cl. 714/6

(57) ABSTRACT

A resolve agent contains a read-only file system, which can interpret file data structures stored on a backup medium according to one or more operating system file systems. The resolve agent provides an interface for communicating with the resolve agent. A restore agent provides the resolve agent with name(s) of file(s) to be restored from the backup medium. The resolve agent reads portions of the file data structures on the backup medium to locate extents of the file(s) to be restored, i.e. the resolve agent ascertains locations that are to be copied from the backup medium. The resolve agent provides the contents of these locations (or their addresses) to the restore agent, which writes the contents (or copies the extents from the backup medium) to a storage device.

### BACKGROUND OF THE INVENTION

1. Field of the Invention

The present invention relates generally to computer data back up and restore systems and, more particularly, to systems that restore data from backup media in a manner that is independent of the operating system that stored the data.

2. Related Art

Computer data centers have an ongoing need to make backup copies of files stored on disks and other computer storage devices, and to selectively restore files that have been maliciously or inadvertently deleted or corrupted. File backup has traditionally been achieved by producing an image backup copy of the entire storage device. Such conventional backup operations copy all blocks of the storage device to a backup medium regardless of whether the blocks have been allocated to files. Typically, the blocks are copied in the order in which they are stored on the storage device to minimize head movement on the storage device as well as to maximize the speed of the backup operation.

Although a data center can produce an image backup relatively quickly, restoring selected files from the image backup poses several problems. To restore selected files, the entire contents of the image backup medium are copied to a temporary “scratch” storage device. Selected files are then copied from the scratch storage device to a destination storage device, which can be the original backed-up or some other storage device. This conventional restoration process is slow because the entire backup medium is copied to the scratch storage device, essentially re-creating the entire original storage device. Since the backed-up storage device, and hence the backup medium, can contain hundreds or thousands of gigabytes of data, such conventional restoration processes can be very time-consuming.

Another drawback to convention file restoration techniques is that the selected files can be copied from the scratch storage device to the destination storage device only by a server that operates under the same operating system as the backed-up storage device. Many data centers use computers that operate under the control of various operating systems, such as Windows NT, Sun Solaris or HP-UX. Each of these and other operating systems includes a set of routines, collectively referred to as a file system, which manage storage devices and files stored thereon. Some operating systems have their own unique file system while other operating systems can use a variety of file systems. Most file systems are, however, mutually incompatible.

A file is stored on a storage device as a series of one or more fragments, commonly referred to as extents. Information regarding where each extent of a file is stored on a storage device is commonly referred to as file mapping information. Operating systems typically store such file mapping information in file data structures with the files on the storage device. The structure and interpretation of file data structures are operating system-specific. Accordingly, a computer operating under one operating system typically cannot read files stored on a storage device by a different operating system. Consequently, a server operating under the same operating system as the backed-up storage device must be used to restore files from that storage device.

In addition, the scratch storage device is dedicated to the restoration process until all the selected files are copied to the destination storage device. This prevents the scratch storage device from being used for other purposes during restoration. Because a data center must be capable of restoring files at all times, one or more storage devices must be continually available for use as a scratch storage device. Consequently, data centers often incur the additional cost associated with having at least one storage device dedicated specifically for file restoration.

### SUMMARY OF THE INVENTION

In one aspect of the invention, an operating system-independent method of restoring a selected file from a disk image on a backup medium to a storage device is disclosed. The method comprises reading from the backup medium file mapping information that identifies one or more extents of the selected file, and using the file mapping information to copy the one or more identified extents from the backup medium directly to the storage device.

In another aspect of the invention, an operating system-independent method of creating a backup copy of a file from a first storage device on a backup medium and restoring the file from the backup medium to a second storage device is disclosed. The method comprises making an image copy of the first storage device on the backup medium; reading from the backup medium file mapping information identifying one or more extents of the file, and using the file mapping information to copy the identified extents from the backup medium to the second storage device.

In a further aspect of the invention, an operating system-independent file restore system for restoring a file from a disk image on a backup medium to a destination storage device is disclosed. The restore system comprises a restore agent configured to use file mapping information identifying extents of files stored on the backup medium to copy one or more extents of the file from the backup medium to the destination storage device. The restore system also comprises a resolve agent configured to obtain relevant file mapping information from the backup medium and to provide the obtained file mapping information to the restore agent.

In a still further aspect of the invention, an operating system-independent resolve agent for providing file mapping information identifying one or more extents of a selected file stored on a backup medium is disclosed. The resolve agent comprises an interface by which information identifying the selected file can be passed to the resolve agent, and by which the file mapping information can be returned by the resolve agent. The resolve agent also comprises file system logic configured to obtain the file mapping information from the backup medium.

In a yet further aspect of the invention, an operating system-independent resolve agent for providing a selected file stored on a backup medium is disclosed. The resolve agent comprises an interface by which information identifying the selected file can be passed to the resolve agent, and by which contents of one or more extents of the selected files can be returned by the resolve agent. The resolve agent also comprises file system logic configured to obtain from the backup medium file mapping information identifying the one or more extents of the selected file. The file system logic is also configured to use the file mapping information to obtain the contents of the identified extents.

In yet another aspect of the invention, an article of manufacture is disclosed. The article of manufacture comprises a computer-readable volume storing computer-executable instructions implementing an operating system-independent method of restoring to a storage device a file from a disk image on a backup medium. The method comprises reading from the backup medium file mapping information identifying one or more extents of the file. The method also comprises using the file mapping information to copy the identified extents from the backup medium to the storage device.

In yet another aspect of the invention, an article of manufacture is disclosed. The article of manufacture comprises a computer-readable volume storing computer-executable instructions implementing an operating system-independent method of creating a backup copy of a file from a first storage device on a backup medium and restoring the file from the backup medium to a second storage device. The method comprises making an image copy of the first storage device on the backup medium. The method also comprises reading from the backup medium file mapping information that identifies one or more extents of the file, and using the file mapping information to copy the one or more identified extents from the backup medium to the second storage device.

### BRIEF DESCRIPTION OF THE DRAWINGS

Further features and advantages of the present invention, as well as the structure and operation of various embodiments of the present invention, are described in detail below with reference to the accompanying drawings. In the drawings, like reference numerals indicate like or functionally similar elements. Additionally, the left-most one or two digits of a reference numeral identifies the drawing in which the reference numeral first appears.

FIG. 1 is a block diagram of an exemplary computer environment, in which the present invention can be practiced.

FIG. 2a is a block diagram of one embodiment of the logical components of a restore system of the present invention.

FIG. 2b is a block diagram of an alternative embodiment of the logical components of a restore system of the present invention.

FIG. 3 is a block diagram of the resolve agent illustrated in FIG. 2 in accordance with one embodiment of the present invention.

FIG. 4 is a diagram of one embodiment of a platform data structure used by the resolve agent of FIGS. 2 and 3.

FIG. 5 is a diagram of a buffer used by the resolve agent of FIGS. 2 and 3 in accordance with one embodiment of the present invention

FIG. 6 is a table of extent types used by the resolve agent of FIGS. 2 and 3 in accordance with one embodiment of the present invention.

### DETAILED DESCRIPTION

The present invention provides operating system-independent methods and systems for restoring to a storage device one or more selected files of a disk image stored on a backup medium. The invention reads from the backup medium file mapping information identifying extents of files also stored on the backup medium. The invention uses this file mapping information to directly copy from the backup medium to the storage device extent(s) of the selected files. In contrast to conventional techniques, direct accessing extents of the selected file enables the invention to restore files regardless of whether it is operating under the same operating system as that used to store the files. In addition, copying the contents of the identified extents directly from the backup medium to the storage device avoids the need to copy the entire disk image to a scratch storage device, reducing the cost and time associated with restoring individual files from a disk image on a backup medium.

As noted, the backup medium contains an image copy of the backed-up storage device. As such, the backup medium also contains a copy of file data structures that store the above-noted file mapping information. In other words, the file data structures are backed up, along with the files, from the original backed-up storage device. Because the backup medium contains an image copy of the backed-up storage device, there is a correspondence between extent locations on the backup medium and extent locations on the backed-up storage device. The file mapping information, therefore, is the same for the original backed-up storage device and the image copy of that storage device which is stored on the backup medium. Thus, the file mapping information stored on the backup medium contains the location of each extent of each file stored in the original backed-up storage device as well as the image copy stored on the backup medium.

In accordance with the present invention, when one or more of the backed-up files are specified to be restored from the backup medium to a storage device, the file data structures stored on the backup medium are accessed to obtain file mapping information for the specified files. As noted, a file system is a set of routines that manage files stored on a storage device. Aspects of the present invention include components that are functionally equivalent to at least a portion of the file system used by the operating system of the backed-up storage device. Such components, referred to herein as file system logic, can read and interpret file mapping information from the backup medium in the same manner as the operating system of the backed-up storage device. This process is referred to herein as “resolving” the file mapping information, and the component of the invention that performs such an operation is referred to as a “resolve agent.”

In accordance with other embodiments, the invention includes file system logic that is functionally equivalent to at least portions of several different file systems. These embodiments can restore files from image backups of storage devices that were under the control of several respective operating systems. Regardless of whether an embodiment can interpret file mapping information according to one or more than one operating system, unlike conventional approaches, the embodiment itself need not operate under the control of the operating system of the backed-up storage device. Hence, the invention provides operating system-independent methods and systems for restoring files thereby eliminating the necessity of using a dedicated server. In alternative embodiments, the present invention also can provide the file mapping information and/or the extents to an external utility through, for example, an application programming interface (API).

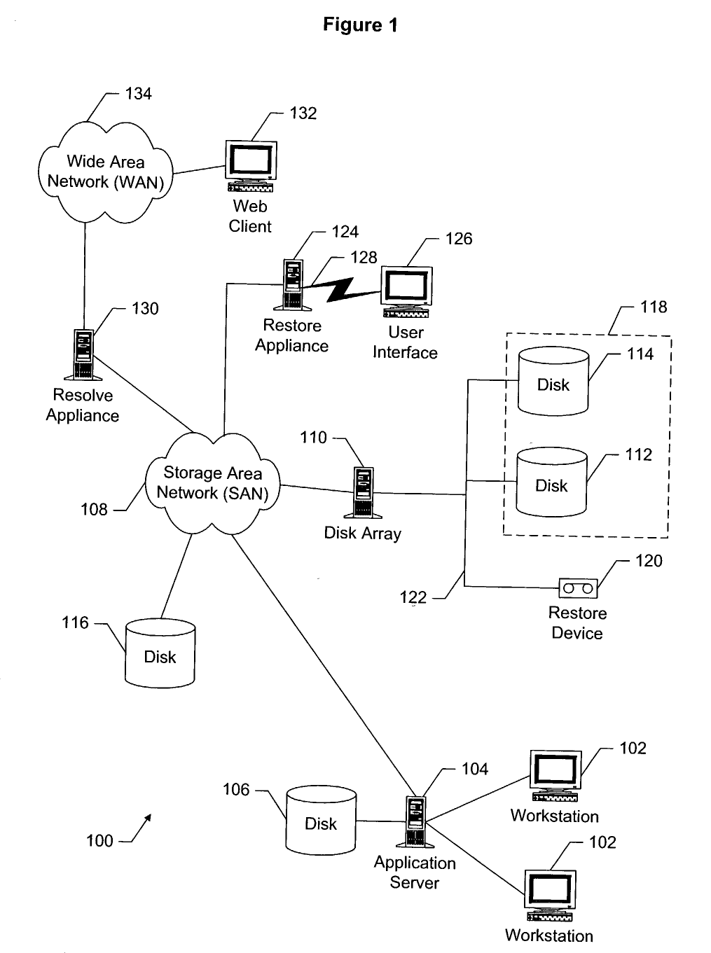

The present invention can be implemented in any computer environment. FIG. 1 is a block diagram of an exemplary computer environment 100, in which embodiments of the present invention can be implemented to locate extents of backed-up files that are to be restored. Workstations or client computers 102 are connected to an application server 104. Application server 104, which includes a local disk 106, is connected to a disk array 110 via a storage area network (SAN) 108. Disk array 110 includes disks 112 and 114. Other disks, such as disk 116, can be connected to SAN 108, such as by other disk arrays (not shown). Application programs executing on application server 104 create and manipulate files stored on disks 106, 112, 114 and/or 116. These disks 106, 112, 114 and/or 116 can be mirrored (not shown) and can be backed up to a backup medium, as described below. Storage area network 108 typically includes fiber channel switches, hubs and/or bridges and associated fiber channel interconnection hardware (not shown), although other interconnect technology can be used. One example of an appropriate disk array and associated equipment is available from Hewlett Packard Company, Palo Alto, Calif., under the trade names SureStore XP-512.

The term “disk” is used herein to refer to a physical storage device which allows random access to the data stored on it, a partition of a physical disk, such as a partition managed by disk array 110, or a multi-disk set. A multi-disk set is a plurality of disks or partitions, such as a stripe set, a span set or a redundant array of inexpensive disks (RAID array), that is treated as a single logical disk. For example, disks 112 and 114 can comprise a multi-disk set 118.

A restore device 120, such as a magnetic tape drive, optical disk drive or other device suitable for reading a backup medium, is connected to a disk array or is otherwise connected to SAN 108. The medium of restore device 120 is preferably, although not necessarily, removable. Restore device 120 and disks 112 and 114 are preferably connected to SAN 108 via a small computer system interconnect (SCSI) bus 122. In some embodiments, restore device 120 is connected to the same disk array 110 as disk 112, to which the files are to be restored. In the exemplary environment shown in FIG. 1, files are to be restored to disk 112, but other disks, such as disk 116 and disk 106, can also be destination storage devices.

A restore appliance 124 provides a platform on which to implement restore systems and methods of the present invention. Restore appliance 124 is preferably a separate computer, such as a personal computer. However, as will be described in detail below, the present invention can run on disk array 110, application server 104, or another computer connected to SAN 108. Restore appliance 124 can be connected to SAN 108 over a dial-up connection or other well-known network connection.

A workstation, keyboard and screen, or other hardware capable of providing a user interface 126 is connected to restore appliance 124 to facilitate human interaction with restore agent 202. The connection 128 between user interface 126 and the restore appliance 124 can be direct or over any combination of networks or communication links. A suitable restore agent and user interface is available from Hewlett-Packard Company, Palo Alto, Calif. under the trade name OmniBack.

Preferably, software executing on application server 104, resolve appliance 130, restore appliance 124, disk array 110 and other components of SAN 108 make restore device 120 and the storage devices (such as disk 112) appear as though they are locally connected via a SCSI bus to the respective servers and appliances.

File restoration is performed as a latter operation or process of a backup and restore procedure. To provide context for the file restoration systems and methods of the present invention, an exemplary backup procedure is described briefly below. In this example files are stored on a conventional mirror disk set. If the files are stored on a non-mirrored disk, a mirror disk set is first created by adding a mirror disk to the disk on which the files are stored, and synchronizing the added disk, as is known in those of ordinary skill in the art. Conventionally, when files on a mirror disk set are to be backed up, the mirror disk set is split by flushing the cache of at least one disk of the mirror disk set, then disconnecting that disk from the mirror disk set, thereby providing a “snapshot disk” containing a snapshot copy of the mirror disk set.

As noted, file backup has traditionally been achieved by producing an image backup copy of the entire storage device. An image or block-for-block copy of the snapshot disk can then be made to a backup medium, such as a backup medium mounted on restore device 120, in a conventional manner. Typically, the blocks are copied in the order in which they are stored on the storage device to minimize head movement on the storage device as well as to maximize the speed of the backup operation. Alternatively, selected files can be copied from the snapshot disk to the backup medium, along with file mapping information for the copied files, as described in co-pending, commonly-assigned U.S. patent application entitled “Operating-System Independent System And Method For Locating Extents Of A File On A Storage Device,” naming as inventors Bradley Taulbee, Scott Spivak, Michael Fleischmann, Gary Cain and Kevin Collins, filed on Jun. 26, 2002 under attorney docket number 10017931-1, which is hereby incorporated herein by reference.

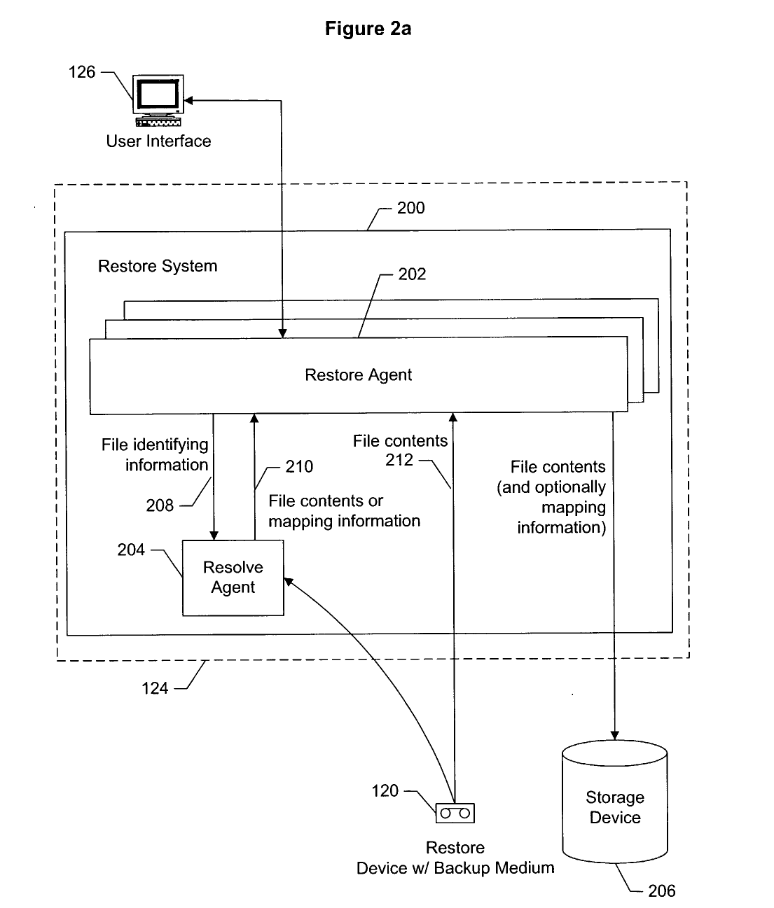

FIG. 2a is a block diagram of the logical components of one embodiment of a restore system 200. The restore system 200 includes one or more restore agents 202 and a resolve agent 204. In this embodiment, resolve agent 204 and restore agents 202 execute on backup appliance 124, as shown by dashed box 124. Advantageously, one resolve agent 204 can service a plurality of restore agents 202, as illustrated in FIG. 2a and described in detail below.

A system administrator initiates a restore operation by issuing commands on user interface 126 to identify the files to be restored, a restore device 120 on which to mount a backup medium containing a backup copy of the files to be restored, and optionally a storage device 206. Alternatively, the file mapping information on the backup medium mounted on restore device 120 can be used to identify the storage device. That is, storage device 206, from which the backup copy was made, can be ascertained from the file mapping information stored on the backup medium. Optionally, the administrator also specifies a backup medium label or other information identifying which magnetic tape or other removable medium to use. This information can be provided to an operator for selection of the desired backup medium. Optionally, the resolve agent 204 and the restore agent 202 read portions of the backup medium mounted on restore device 120 and display on the user interface 126 a list of the files stored on the backup medium, thus enabling the system administrator to select one or more files for restoration.

For each file to be restored, restore agent 202 sends file identifying information 208 to resolve agent 204. For each identified file, file identifying information 208 can include the filename of the file, the directory or folder in which the file is organized and information identifying the storage device, from which the backup copy was made, or a combination thereof. Resolve agent 204 uses this file identifying information 204 to read file data structures on a backup medium mounted on restore device 120 and to locate extents of the specified files on the backup medium.

Resolve agent 204 sends the extents, or alternatively their file mapping information, 210 to restore agent 202. Restore agent 202 writes the extent contents to storage device 206. Alternatively, restore agent 202 uses the file mapping information to copy extent contents 212 from the backup medium mounted on restore device 120 to storage device 206.

In certain embodiments where restore agent 202 writes the extent contents to storage device 206, restore agent 202 uses native operating system I/O requests on restore appliance 124 to write to storage device 206. Recall that storage device 206 appears to be locally connected to restore appliance 124. Restore agent 202 uses “open with overwrite” I/O operations to write to storage device 206, thereby overwriting files on the storage device with their backup counterparts from the backup medium.

FIG. 2b is a block diagram of an alternative embodiment of file restore system 200 of the present invention. As shown in FIG. 2b, in embodiments where restore agent 202 receives extent location information (rather than extent contents), restore agent 202 initiates a copy operation using a data mover 214 to copy the extents from restore device 120 to storage device 206. Data mover 214 can be a well-known SCSI XCOPY engine located in SAN 108, restore device 120, disk array 110, storage device 206 or other component of computer environment 100. If storage device 206 is actively being accessed by an operating system, before extents can be copied from restore device 120 to the storage device, all caches storing data from the storage device are to be flushed or invalidated.

Typically, storage media is divided into blocks having the same physical size, although block size can vary from physical disk to physical disk. It should be appreciated, however, that some storage media, notably most magnetic tapes, are not divided into equally-sized blocks. Typically, a header, written at the beginning of a magnetic tape, identifies the range of addresses (such as disk block numbers) stored on the tape. In certain circumstances, such as in a multi-disk set, all the space of the multi-disk set is treated as one contiguous space of blocks, making multiple disks appear as one single disk.

In certain circumstances, such as in a multi-disk set, all the space of the multi-disk set is treated as one contiguous space of blocks, making multiple disks appear as one single disk.

As is well known in the art, an extent is a logically contiguous group of blocks. Extents are typically identified by the block number of the first block of the extent and the number of blocks in the extent. An extent can also be identified by the block number of the first block and the block number of the last block of the extent or by any other addressing method that permits accessed to the extent. Not all extents on a disk are necessarily the same size. Some files (“contiguous files”) are stored in a single extent, but most files are stored in a series of discontiguous extents. As noted, file data structures store file mapping information which includes the location of each extent.

Referring to FIGS. 2a and 2b, for each file to be restored, resolve agent 204 uses file mapping information 210 stored in the file data structures or elsewhere on the backup medium 120 to ascertain the location of the file on the backup medium. As noted, in this example, file mapping information includes the beginning block number and number of blocks in each extent of each file. Resolve agent 204 then locates these blocks on backup medium 120 and uses the file mapping information to read the contents of the file extents from restore device 120. Resolve agent 204 returns the contents of the extents to restore agent 202, which then writes these contents to storage device 206. Alternatively, resolve agent 204 sends at least some of this file mapping information to restore agent 202, which then copies the identified blocks from restore device 120 to storage device 206.

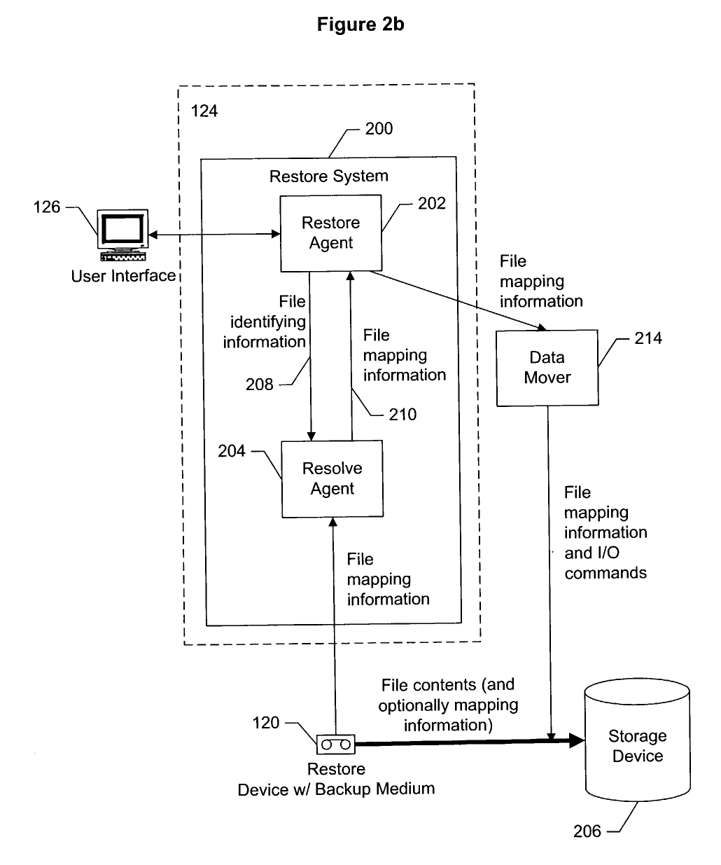

FIG. 3 is a block diagram of resolve agent 204. Resolve agent 204 contains an interface and three components. Specifically, resolve agent 204 comprises an application programming interface (API) 300, an analyzer 302, a logical volume manager 304 and at least one physical reader 306, although these functions need not be segregated exactly shown. This embodiment of resolve agent 204 will be described with reference to an exemplary backup operation that produced three physical backup tapes 324. For simplicity, the term “backup medium” is used herein to refer to one or more backup tapes or other backup media. A physical reader 306 is created for each restore device 322, as shown in FIG. 3. In this example, the three backup tapes are respectively mounted on three restore devices 322a, 322b and 322c, so they can be accessed in parallel. Alternatively, the three tapes can be mounted one at a time on a single restore device 322.

Analyzer 302, logical volume manager 304 and physical readers 306 provide a hierarchy of abstractions of backup medium 324. Each component of resolve agent 204 accepts a request from a component or API 300 directly above it made at a higher level of abstraction and, in response, generates one or more requests to a resolve agent component directly below it at a lower level of abstraction, that is, addressed with a finer degree of resolution to a location on a backup medium 324 than the higher level request. Significantly, API 300, analyzer 302 and logical volume manager 304 are operating system independent. Physical reader 306 is natively compiled to execute under the control of the operating system of restore appliance 124.

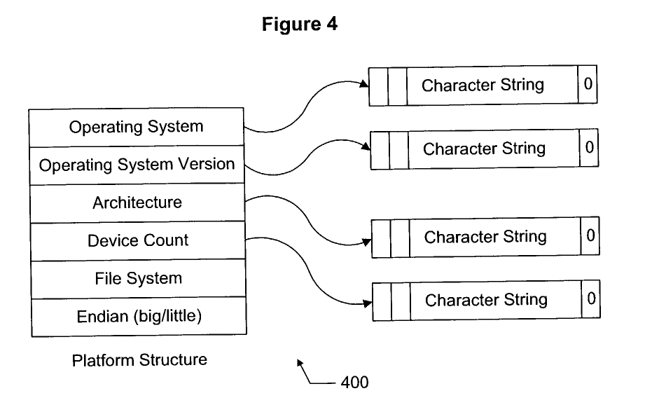

Advantageously, restore agent 202 and other software components (not shown) can interact with resolve agent 204 through API 300. API 300 provides a way for restore agent 202 or an external component to specify to resolve agent 204 what files are to be resolved. In addition, restore agent 202 specifies the location and size of an output buffer, in which resolve agent 204 can return file mapping information for the specified files. One embodiment of this output buffer is described below with reference to FIG. 5.

In one embodiment, API 300 includes six calls: ResolveOpen( ), ResolveGetFirstData( ), ResolveGetNextData( ), ResolveGetFirstBuffer( ), ResolveGetNextBuffer( ), ResolveClose( ) and ResolveGetErrorCode( ), although not all these calls need to be used in any particular implementation.

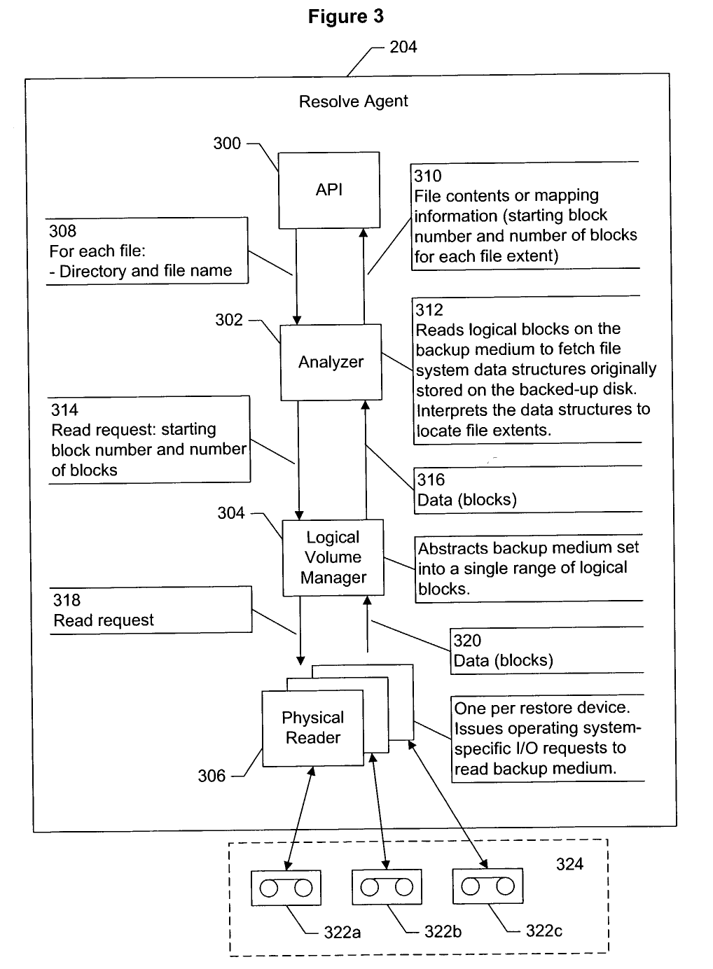

The ResolveOpen API call conditions resolve agent 204 for a particular restore device and platform combination. This API call has two parameters, “*platform,” and “*location”. The parameter “*platform” defines the platform or operating system of the backed-up system (and thus the system, to which the files are to be restored). This parameter points to a platform data structure 400, one embodiment of which is shown in FIG. 4. Platform data structure 400 includes information pertaining to storage device 206, such as the type and version of the operating system, etc. The parameter “*location” specifies restore device 120. These parameters are passed to API 300 from an external component (not shown), such as restore agent 202. Restore appliance 124 establishes connections to restore device 120 and storage device 206, so these devices appears to be locally connected to restore appliance 124.

The ResolveGetFirstData call causes resolve agent 204 to begin resolving a list of specified files. The ResolveGetFirstData API function call includes five parameters: fileCount, **filenames, *continueFlag, bufferSize and *buffer. The parameter “fileCount” indicates the number of files in the “filenames” array. The parameter “**filenames” is an array of filenames to be resolved. API 300 passes this parameter to analyzer 302. This is indicated on FIG. 3 at 308.

The parameter “*continueFlag” is a return parameter that indicates all the file contents could not be returned in one buffer, and restore agent 202 should call ResolveGetNextData to retrieve one or more additional buffers of file contents. The parameter “bufferSize” denotes the size of the output buffer containing the requested file contents. The parameter “*buffer” is a return parameter that points to the noted output buffer containing file contents. This parameter is passed from analyzer 302 to API 300 as shown by reference numeral 310 in FIG. 3.

ResolveGetNextData(*continueFlag, bufferSize, *buffer) returns additional buffers when all the file contents could not be returned in one buffer. The parameter “*continueFlag” is a return parameter which denotes that another call to ResolveGetNextData is necessary. The parameters “bufferSize” and “*buffer” are the same as in ResolveGetFirstData.

The ResolveGetFirstBuffer call is similar to the ResolveGetFirstData call, except that the ResolveGetFirstBuffer call returns file mapping information, instead of file contents. The ResolveGetFirstBuffer call causes resolve agent 204 to begin resolving a list of specified files. The ResolveGetFirstBuffer API function call includes five parameters: fileCount, **filenames, *continueFlag, bufferSize and *buffer. The parameter “fileCount” indicates the number of files in the “filenames” array. The parameter “**filenames” is an array of filenames to be resolved. API 300 passes this parameter to analyzer 302. This is indicated on FIG. 3 at 308.

The parameter “*continueFlag” is a return parameter that indicates all the mapping information could not be returned in one buffer, and restore agent 202 should call ResolveGetNextBuffer to retrieve one or more additional buffers of file mapping information. The parameter “bufferSize” denotes the size of the output buffer containing the requested file mapping information. The parameter “*buffer” is a return parameter that points to the noted output buffer containing file mapping information. This parameter is passed from analyzer 302 to API 300 as shown by reference numeral 310 in FIG. 3.

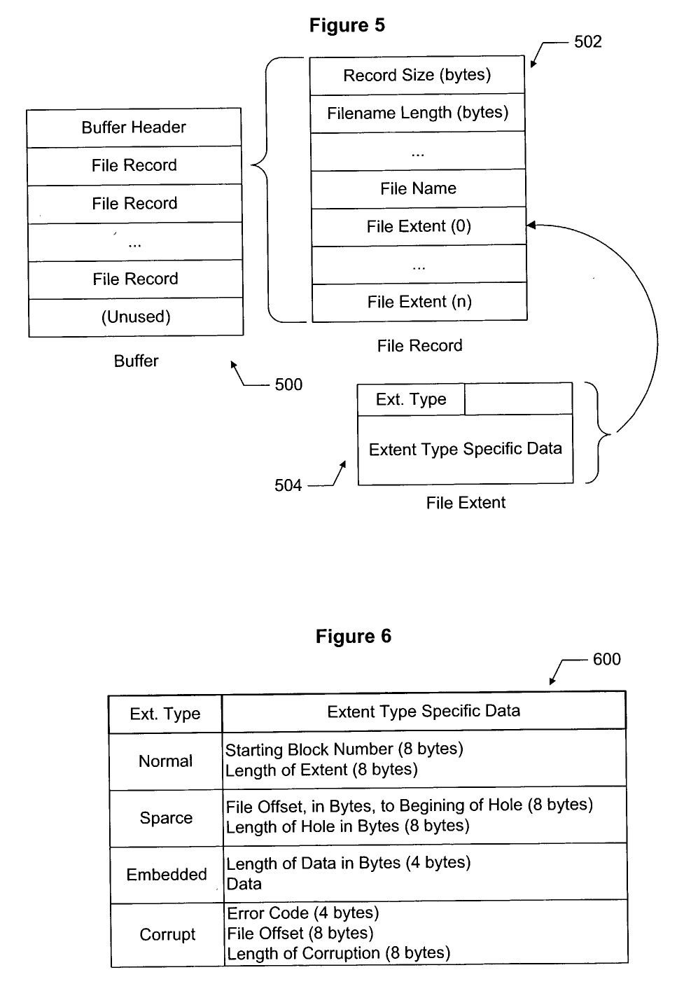

FIG. 5 is a block diagram of one embodiment of the structure of an output buffer 500, in which file mapping information can be returned. The file mapping information for each file is contained in a file record 502, and each extent is described in a “file extent” data structure 504. FIG. 6 depicts a table 600 of extent types and the specific data that is included in the file extent record 504 for the specific type of extent. This specific data is referred to as “extent types specific data” in FIGS. 5 and 6. For example, “Sparse” files have holes, that is, unallocated disk space, in them. These holes have never been written, and typically read back as zeroes. “Embedded files” are very small files (typically less than 2 K bytes) and are stored in a header block of the file structure, rather than having space allocated to them, as normal files do. Resolve agent 204 returns the contents of embedded files, rather than their mapping information, in buffer 500.

ResolveGetNextBuffer(*continueFlag, bufferSize, *buffer) returns additional buffers when all the mapping information could not be returned in one buffer. The parameter “*continueFlag” is a return parameter which denotes that another call to ResolveGetNextBuffer is necessary. The parameters “bufferSize” and “*buffer” are the same as in ResolveGetFirstBuffer.

ResolveClose( ) cleans up the internal data structures and stops threads of resolve agent 204. This is described in greater detail below.

ResolveGetErrorCode( ) returns an error code for the last call to the resolve agent 204.

Returning to FIG. 3, analyzer 302 accepts file identifying information, such as the filenames of the files to be restored and the directories or folders in which these files are organized. Analyzer 302 receives this information through the ResolveOpen( ) API call described above.

For each extent of each file to be resolved, at 312 analyzer 302 reads and interprets file data structures on backup medium 324 to locate the beginning block number and size (number of blocks) of the extent, as it was stored on the backed-up storage device. Analyzer 302 treats backup medium 324 as a space of blocks, i.e. the blocks of the backed-up disk. The resolve agent 204 treats backup medium 324 as though it were the backed-up disk, i.e. the resolve agent reads blocks on the backup medium as though it were reading blocks on the backed-up disk.

To read the file data structures, analyzer 302 issues read requests 314 to logical volume manager 304. Each such read request specifies a starting block number and a number of blocks to read. Since analyzer 302 is written with knowledge of the layout of the file data structures used by the operating system of the backed-up system, analyzer 302 can interpret the file data structures stored on backup medium 324, and instructions (“file system logic”) in analyzer 302 can select appropriate blocks on backup medium 324 to read the necessary file data structures. Logical volume manager 304 returns 316 the blocks requested by analyzer 302, and the analyzer analyzes the file data structures returned in these blocks. The file data structures on backup medium 324 store extent addresses and sizes in terms of disk blocks.

Essentially, analyzer 302 includes a “read-only” file system for the file data structures used on the storage device, from which the backup was made. That is, analyzer 302 contains file system logic necessary to locate the extents of a file on backup medium 324. Importantly, analyzer 302 does not need to contain file system logic necessary to allocate blocks or create or extend files on a storage device. This read-only file system includes file system logic necessary to read the master file table, I-node or other file system-specific or operating system-specific file data structures on backup medium 324 to ascertain the backed-up storage device's block size and other parameters to interpret the directory structure and file mapping information stored on backup medium 324 and, thereby, locate extents of the specified files on the backup medium.

Most computer architectures store multi-byte data, such as 32-bit “long” integers. In some such architectures, the least significant eight bits of data is stored at the lowest addressed byte of the multi-byte data. However, in other computer architectures, the least significant eight bits of data is stored in the highest addressed byte. This is commonly referred to as “little endian” and “big endian”. If analyzer 302 is executing on a computer that has a different endian than the backed-up system, analyzer 302 converts data, such as starting block numbers, it extracts from the blocks returned by logical volume manager 304. The endian of disk 322 is indicated in platform data structure 400.

Logical volume manager 304 accepts 314 I/O requests addressed to blocks and generates 318 corresponding I/O requests to the appropriate backup medium mounted on restore device 322a, 322b or 322c. Logical volume manager 304 abstracts backup medium 324 into a contiguous span of blocks starting at block number zero, even if the backup medium 324 is a multi-volume backup medium or the backup data begins at a location on any of the backup tapes.

Logical volume manager 304 calculates which restore device 322a, 322b and/or 322c contains the block(s) requested by analyzer 302. Logical volume manager 304 then passes (318), to the physical reader(s) 306 corresponding to the appropriate restore device(s) 322a, 322b and/or 322c, requests to read these blocks. Physical readers 306 return at 320 data from the backup medium to logical volume manager 304, which aggregates this data into blocks and returns (316) the blocks to analyzer 302.

Using UNIX “superuser” privilege, or a corresponding privilege on backup appliance 124, physical reader 306 is able to read any location on the backup medium 324. Physical readers 306 issues I/O calls to the operating system of backup appliance 124 to read from restore devices 322a, 322b and 322c. Physical reader 306 is, therefore, natively compiled to run under the operating system of backup appliance 124.

When resolve agent 204 receives a ResolveGetFirstBuffer( ) or ResolveGetFirstData( ) call, it spawns a thread of execution to handle the request. For each file identified in the ResolveGetFirstBuffer( ) or ResolveGetFirstData( ) call, resolve agent 204 reads file data structures on backup medium 324 to ascertain the file's mapping information, and places that mapping information or the file contacts in a buffer. If the buffer becomes full, the thread is paused. Once the caller receives buffer, the thread is resumed and continues placing mapping information or contents into the buffer. Multiple threads enable resolve agent 204 to concurrently handle requests from multiple callers and facilitates multiple simultaneous restore operations from multiple backup mediums to multiple destination storage devices.

Preferably, the source code of analyzer 302 contains file system logic that enables it to read backup media produced from several file systems. In such embodiments, a compile-time parameter can be implemented to control which file system logic is to be compiled at a given time. In one embodiment, file system logic that is not selected is not compiled. Alternatively, analyzer 302 is compiled with file system logic that enables it to read multiple file systems. In this latter embodiment, analyzer 302 selects, on a case-by-case basis, which file system logic to utilize. This determination can be based on, for example, the file system of the system from which backup medium 324 was produced, or it can be specified in an API call. Analyzer 302 can use platform structure 400 to identify the operating system and file system. Alternatively, analyzer 302 independently ascertains the file system by reading portions of backup medium 324. Typically, the first few blocks of a disk contain data, such as character strings, that identify the file system, and these blocks are included on backup medium 324.

Writing an analyzer 302 that can interpret file mapping information and locate extents is within the skill of an ordinary practitioner, if documentation of the location and layout of the file data structures is available or can be ascertained by “reverseengineering”. Some file systems and their corresponding file data structures, such as Windows NT Version 4.0 (NTFS), FAT16, FAT32, HPUX, UFS, HFS and Digital/Compaq Files-11, are well documented, so writing an analyzer 302 for these file systems is straightforward. Other file system, such as Veritas V3, Veritas V4 and Veritas V4, are partially documented. Yet other file systems must be reverse engineered to understand their file data structures.

Reverse engineering a file system involves ascertaining the location and layout of file data structures stored on a disk and used to keep track of files on the disk and the location of the extents of these files. Several tools are available to facilitate this reverse engineering, and some file systems are partially documented. For example, Veritas has “manual pages” that partially document the file system.

Reverse engineering a file system involves several steps. A quiescent copy of a disk containing a number of representative files and directories (folders) should be obtained. Native commands, management utilities and programs provided with the operating system or written by a programmer can be used to obtain a user-visible view of information about the files and folders on the disk. For example, the “find”, “ls” and “dir” commands, with various options, can be issued to obtain a list of files and sizes. Some of these commands can also provide file mapping information, which is helpful in verifying the location and layout of the file data structures. Documentation provided with the operating system, particularly the operating system's API, describes I/O calls that can be made to retrieve information about files or disks that might not be available through the native commands mentioned above. Dump utilities and file system debuggers, such as WinHex, DISKEDIT and fsdb (which ships with HP-UX 11.0), can be used to produce human readable representations of the data stored on the disk. If no such dump utility is available, one can easily be written, although it might be necessary to mount the quiescent disk as a “foreign” volume, and superuser privilege might be required, allowing the dump program to read all logical blocks of the disk, without intervention by the operating system's file system. Alternatively, resolve agent 204 can be accessed by a restore agent or other component (“client”) using a web interface. Returning to FIG. 1, restore appliance 124 can include a web server, such as the Apache web server, available from the Apache Software Foundation. Alternatively, the resolve agent can run on a separate “resolve appliance” 130, which also includes a web server. In either case, a web client 132 can access the computer 130 or 124 on which the resolve agent 204 runs over a LAN or a wide area network (WAN) 134, such as the Internet. Well-known remote procedure calls (RPCs), such as those supported by the Simple Object Access Protocol (SOAP), can be used by the web client 132 to invoke procedures in resolve agent 204 and return data to the web client. SOAP supports RPCs by enclosing the remote procedure calls and data in XML tags and transporting them between a web client 132 and the computer on which resolve agent 204 runs, i.e. resolve appliance 130 or backup appliance 124, using the hypertext transport protocol (HTTP). In this way, resolve agent 204 can provide a remote procedure calling interface, specifically a web interface, to client 132.

Although resolve agent 204 is described as reading file data structures to resolve each file, the resolve agent can cache these structures in memory to reduce the number of I/O operations performed.

Resolve agent 204 and restore agent 202 are preferably implemented in software that can be stored in the memory, and control the operation, of a computer. Furthermore, the resolve agent 204 and restore agent 202 can be stored on a removable or fixed computer-readable volume, such as a CD-ROM, DVD, hard disk, floppy disk, magneto-optical device or magnetic tape. In addition, this software can be transmitted over a wireless or wired communication line or network.

While various embodiments of the present invention have been described above, it should be understood that they have been presented by way of example only, and not limitation. For example, although operation of the present invention has been described in terms of locating blocks of one or more files, information can be stored on a storage device without necessarily organizing it into a file. The more general term “data” is, therefore, also used to refer to information stored on a disk, backup medium or other storage device. As another example, in the above exemplary aspects and embodiments, the backup medium contains an image copy of an entire storage device. However, it should be understood that embodiments of the invention can also restore files from a backup medium that contains less than an image copy of an entire storage device, provided the backup medium contains file mapping information for the files that are to be restored. In another example, it was noted above that a system administrator initiates a restore operation by issuing commands on user interface 126 to identify the files to be restored. It should be understood, however, that the files to be restored can be identified through any other means and by any other source. Thus, the breadth and scope of the present invention should not be limited by any of the above-described exemplary embodiments, but should be defined only in accordance with the following claims and their equivalents.

What is claimed is:

1. An operating system-independent method of restoring a selected file from a disk image on a backup medium to a storage device, comprising:
reading from the backup medium file mapping information that identifies one or more extents of the selected file; and
using the file mapping information to copy the one or more identified extents from the backup medium to the storage device.

2. The method of claim 1, wherein the file mapping information is used in accordance with one of a plurality of file systems.

3. The method of claim 1, wherein for each of the one or more extents of the selected file, the file mapping information comprises a starting location and a size of the extent.

4. The method of claim 1, wherein the file is copied to a location on the storage device, the location being specified by the file mapping information.

5. The method of claim 1, wherein the file mapping information identifies the storage device.

6. The method of claim 1, wherein the storage device comprises a multi-disk set, and the file mapping information identifies each disk of the multi-disk set.

7. An operating system-independent method of creating a backup copy of a file from a first storage device on a backup medium and restoring the file from the backup medium to a second storage device, comprising:
making an image copy of the first storage device on the backup medium;
reading from the backup medium file mapping information identifying one or more extents of the file; and
using the file mapping information to copy the one or more identified extents from the backup medium to the second storage device.

8. The method of claim 7, wherein the file mapping information is used in accordance with one of a plurality of file systems.

9. The method of claim 7, wherein for each of the one or more extents of the selected file the file mapping information comprises a starting location and a size of the extent.

10. The method of claim 7, wherein the selected file is copied to a location on the storage device which is specified by the file mapping information.

11. The method of claim 7, wherein the file mapping information identifies the second storage device.

12. The method of claim 7, wherein the second storage device comprises a multi-disk set, and the file mapping information identifies each disk of the multi-disk set.

13. The method of claim 7, wherein the first storage device comprises a mirror disk set and the making the image copy comprises:
disconnecting a mirror disk from the mirror disk set; and
copying at least a portion of the disconnected mirror disk to the backup medium.

14. The method of claim 7, wherein the first storage device comprises a mirror disk set and the making the image copy comprises:
disconnecting a mirror disk from the mirror disk set; and
creating an image copy of the entire disconnected mirror disk on the backup medium.

15. An operating system-independent file restore system for restoring a file from a disk image on a backup medium to a storage device, comprising:
a restore agent configured to use file mapping information identifying extents of files stored on the backup medium to copy one or more extents of the file from the backup medium to the storage device; and
a resolve agent configured to obtain relevant file mapping information from the backup medium, and to provide the obtained file mapping information to the restore agent.

16. The restore system of claim 15, wherein the resolve agent comprises an analyzer configured to interpret file system data structures stored on the backup medium to obtain the file mapping information.

17. The restore system of claim 15, wherein the resolve agent comprises an analyzer configured to interpret file system data structures stored on the backup medium to obtain the file mapping information according to one of a plurality of operating systems.

18. The restore system of claim 15, wherein the resolve agent comprises:
an analyzer configured to interpret file system data structures to obtain the file mapping information; and
a logical volume manager configured to aggregate data from the backup medium into blocks containing file system data structures and to provide the blocks to the analyzer.

19. The restore system of claim 15, wherein the resolve agent comprises:
an analyzer configured to interpret file system data structures to obtain the file mapping information;
a logical volume manager configured to aggregate at least a portion of the data into blocks containing file system data structures and to provide the blocks to the analyzer; and
a physical reader configured to read data from the backup medium and provide the data to the logical volume manager.

20. An operating system-independent resolve agent for providing file mapping information that identifies one or more extents of a selected file stored on a backup medium, comprising:
an interface by which information identifying the selected file can be passed to the resolve agent, and by which the file mapping information can be returned by the resolve agent; and
file system logic configured to read the file mapping information from the backup medium.

21. The resolve agent of claim 20, wherein the file system logic is configured to obtain the file mapping information according to one of a plurality of operating systems.

22. The resolve agent of claim 20, wherein the file system logic is configured to obtain the file mapping information according to one of a plurality of operating systems and the one of the plurality of operating systems is specified through the interface.

23. The resolve agent of claim 20, wherein the file system logic comprises an analyzer configured to interpret file system data structures stored on the backup medium to obtain the file mapping information.

24. The resolve agent of claim 20, wherein the file system logic comprises an analyzer configured to interpret file system data structures stored on the backup medium to obtain the file mapping information according to one of a plurality of operating systems.

25. The resolve agent of claim 20, wherein the file system logic comprises:
an analyzer configured to interpret file system data structures stored on the backup medium to obtain the file mapping information; and
a logical volume manager configured to aggregate data from the backup medium into blocks containing file system data structures and to provide the blocks to the analyzer.

26. The resolve agent of claim 20, wherein the file system logic comprises:
an analyzer configured to interpret file system data structures to obtain the file mapping information;
a logical volume manager configured to aggregate at least a portion of the data into blocks containing file system data structures and to provide the blocks to the analyzer; and
a physical reader configured to read data from the backup medium and provide the data to the logical volume manager.

27. An operating system-independent resolve agent for providing contents of a selected files stored on a backup medium, comprising:
an interface by which information identifying the selected file can be passed to the resolve agent, and by which contents of one or more extents of the selected files can be passed by the resolve agent; and
file system logic configured to obtain from the backup medium file mapping information identifying the one or more extents of the selected file, and to use the file mapping information to obtain the contents of the one or more identified extents.

28. The resolve agent of claim 27, wherein the file system logic is configured to obtain the file mapping information according to one of a plurality of operating systems.

29. The resolve agent of claim 27, wherein the file system logic is configured to obtain the file mapping information according to one of a plurality of operating systems and the one of the plurality of operating systems is specified through the interface.

30. The resolve agent of claim 27, wherein the file system logic comprises an analyzer configured to interpret file system data structures stored on the backup medium to obtain the file mapping information.

31. The resolve agent of claim 27, wherein the file system logic comprises an analyzer configured to interpret file system data structures stored on the backup medium to obtain the file mapping information according to one of a plurality of operating systems.

32. The resolve agent of claim 27, wherein the file system logic comprises:
an analyzer configured to interpret file system data structures to obtain the file mapping information; and
a logical volume manager configured to aggregate data from the backup medium into blocks containing file system data structures and to provide the blocks to the analyzer.

33. The resolve agent of claim 27, wherein the file system logic comprises:
an analyzer configured to interpret file system data structures to obtain the file mapping information;
a logical volume manager configured to aggregate at least a portion of the data into blocks containing file system data structures and to provide the blocks to the analyzer; and
a physical reader configured to read data from the backup medium and provide the data to the logical volume manager.

34. An article of manufacture, comprising:
a computer-readable volume storing computer-executable instructions, the instructions implementing an operating system-independent method of restoring to a storage device a file from a disk image on a backup medium to a storage device, comprising:
reading from the backup medium file mapping information identifying one or more extents of the file; and
using the file mapping information to copy the identified extents from the backup medium to the storage device.

35. The article of manufacture of claim 34, wherein the file mapping information is used in accordance with one of a plurality of operating systems.

36. An article of manufacture, comprising:
a computer-readable volume storing computer-executable instructions, the instructions implementing an operating system-independent method of creating on a backup medium a backup copy of a first storage device, and restoring a selected file from the backup medium to a second storage device, comprising:
making an image copy of the first storage device on the backup medium;
reading file mapping information identifying one or more extents of the selected file from the backup medium; and
using the file mapping information to copy from the backup medium to the second storage device the one or more identified extents.

37. The article of manufacture of claim 36, wherein the file mapping information is used in accordance with one of a plurality of operating systems.
